(19) United States
(12) Patent Application Publication
(10) Pub. No.: US 2019/0065878 A1
(43) Pub. Date: Feb. 28, 2019

(54) FUSION OF RADAR AND VISION SENSOR SYSTEMS

(71) Applicant: GM Global Technology Operations LLC, Detroit, MI (US)

(72) Inventors: Shuqing Zeng, Sterling Heights, MI (US); Igal Bilik, Rehovot (IL); Shahar Villeval, Tel Aviv (IL); Yasen Hu, Sterling Heights, MI (US)

(21) Appl. No.: 15/683,144

(22) Filed: Aug. 22, 2017

(51) Int. Cl. G06K 9/32; G06T 7/70; G06T 7/11

(52) U.S. Cl. CPC G06K 9/3233; G06T 7/11; G06T 7/70

(57) ABSTRACT

A system and method to fuse a radar system and a vision sensor system include obtaining radar reflections resulting from transmissions of radio frequency (RF) energy. The method includes obtaining image frames from one or more vision sensor systems, and generating region of interest (ROI) proposals based on the radar reflections and the image frames. Information is provided about objects detected based on the ROI proposals.

### INTRODUCTION

The subject disclosure relates to the fusion of radar and vision sensor systems.

Vehicles (e.g., automobiles, trucks, construction equipment, farm equipment, automated factory equipment) are increasingly outfitted with sensor systems that facilitate enhanced or automated vehicle operation. For example, when a sensor system detects an object directly ahead of the vehicle, a warning may be provided to the driver or automated braking or other collision avoidance maneuvers may be implemented. The information obtained by the sensor systems must facilitate the detection and identification of objects surrounding the vehicle. One type of sensor system, a light detection and ranging (lidar) system, provides a dense point cloud (i.e., a dense set of reflections) that can be helpful in identifying a potential region of interest for further investigation. But, lidar systems have weather and other limitations. Accordingly, it is desirable to provide fusion of radar and vision sensor systems.

### SUMMARY

In one exemplary embodiment, a method of fusing a radar system and a vision sensor system includes obtaining radar reflections resulting from transmissions of radio frequency (RF) energy. The method also includes obtaining image frames from one or more vision sensor systems, and generating region of interest (ROI) proposals based on the radar reflections and the image frames. Information is provided about objects detected based on the ROI proposals.

In addition to one or more of the features described herein, a radar map is obtained from the radar reflections. The radar map indicates an intensity of processed reflections at respective range values.

In addition to one or more of the features described herein, a visual feature map is obtained from the image frames. Obtaining the visual feature map includes processing the image frames using a neural network.

In addition to one or more of the features described herein, generating the ROI proposals includes finding an overlap among features of the visual feature map and points in the radar map.

In addition to one or more of the features described herein, obtaining the radar map includes projecting three-dimensional clusters onto an image plane.

In addition to one or more of the features described herein, obtaining the three-dimensional clusters is based on performing a fast Fourier transform of the radar reflections.

In addition to one or more of the features described herein, obtaining the visual feature map includes performing a convolutional process.

In addition to one or more of the features described herein, performing the convolutional process includes performing a series of convolutions of the image frames with a kernel matrix.

In addition to one or more of the features described herein, providing the information includes providing a display to a driver of a vehicle that includes the radar system and the vision sensor system.

In addition to one or more of the features described herein, providing the information is to a vehicle system of a vehicle that includes the radar system and the vision sensor system, the vehicle system including a collision avoidance system, an adaptive cruise control system, or an autonomous driving system.

In another exemplary embodiment, a fusion system includes a radar system to obtain radar reflections resulting from transmissions of radio frequency (RF) energy. The system also includes a vision sensor system to obtain image frames from one or more vision sensor systems, and a controller to generate region of interest (ROI) proposals based on the radar reflections and the image frames, and provide information about objects detected based on the ROI proposals.

In addition to one or more of the features described herein, the controller obtains a radar map from the radar reflections, the radar map indicating an intensity of processed reflections at respective range values.

In addition to one or more of the features described herein, the controller obtains a visual feature map based on processing the image frames using a neural network.

In addition to one or more of the features described herein, the controller generates the ROI proposals based on finding an overlap among features of the visual feature map and points in the radar map.

In addition to one or more of the features described herein, the controller obtains the radar map based on projecting three-dimensional clusters onto an image plane.

In addition to one or more of the features described herein, the controller obtains the three-dimensional clusters based on performing a fast Fourier transform of the radar reflections.

In addition to one or more of the features described herein, the controller obtains the visual feature map based on performing a convolutional process.

In addition to one or more of the features described herein, the controller performs the convolutional process based on performing a series of convolutions of the image frames with a kernel matrix.

In addition to one or more of the features described herein, the controller provides the information as a display to a driver of a vehicle that includes the radar system and the vision sensor system.

In addition to one or more of the features described herein, the controller provides the information to a vehicle system of a vehicle that includes the radar system and the vision sensor system, the vehicle system including a collision avoidance system, an adaptive cruise control system, or an autonomous driving system.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a system to perform fusion of radar and vision sensor systems in a vehicle according to one or more embodiments;

FIG. 2 is a process flow of a method of performing fusion of radar and vision sensor systems according to one or more embodiments;

FIG. 3 shows an exemplary results obtained in the process flow of a method of performing fusion of radar and vision sensor systems according to one or more embodiments; and

FIG. 4 shows an exemplary image with features from a visual feature map and points from a range map used to generate region of interest proposals according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

As previously noted, vehicle systems that provide warnings or take automated actions require information from sensor systems that identify regions of interest (ROI) for investigation. A lidar system transmits pulsed laser beams and determines the range to detected objects based on reflected signals. The lidar system obtains a more dense set of reflections, referred to as a point cloud, than a radar system. But, in addition to a relatively higher cost as compared with radar systems, lidar systems require dry weather and do not provide Doppler information like radar systems. Radar systems generally operate by transmitting radio frequency (RF) energy and receiving reflections of that energy from targets in the radar field of view. When a target is moving relative to the radar system, the frequency of the received reflections is shifted from the frequency of the transmissions. This shift corresponds with the Doppler frequency and can be used to determine the relative velocity of the target. That is, the Doppler information facilitates a determination of the velocity of a detected object relative to the platform (e.g., vehicle) of the radar system.

Embodiments of the systems and methods detailed herein relate to using a radar system to identify ROI. A fusion of radar and vision sensor systems is used to achieve the performance improvement of a lidar system as compared with the radar system alone while providing benefits over the lidar system in terms of better performance in wet weather and the ability to additionally obtain Doppler measurements. Specifically, a convolutional neural network is used to perform feature map extraction on frames obtained by a video or still camera, and this feature map is fused with a range map obtained using a radar system. The fusion according to the one or more embodiments will be more successful the higher the angular resolution of the radar system. Thus, the exemplary radar system discussed for explanatory purposes is an ultra-short-range radar (USRR) system. Cameras are discussed as exemplary vision sensor systems.

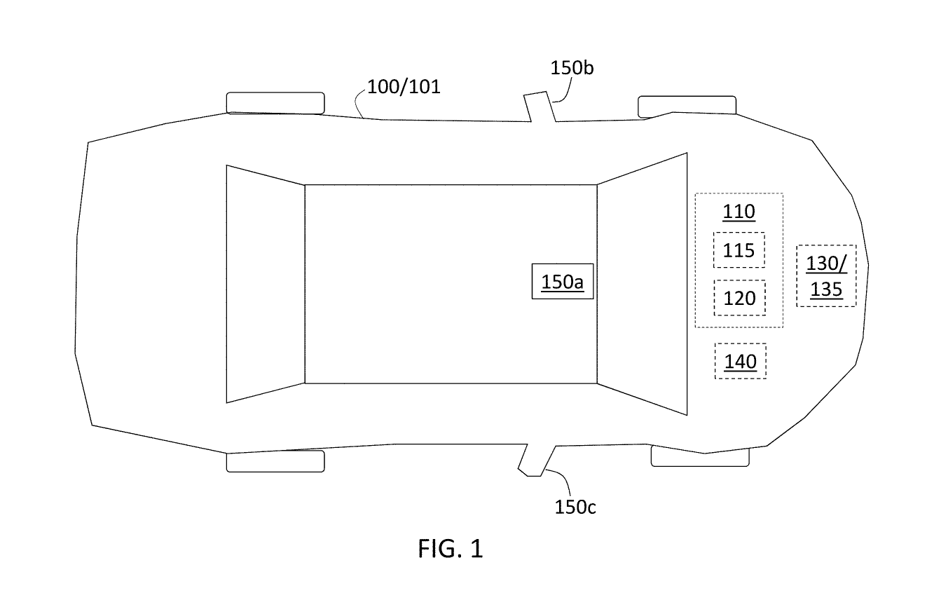

In accordance with an exemplary embodiment, FIG. 1 is a block diagram of a system to perform fusion of radar and vision sensor systems in a vehicle 100. The vehicle 100 shown in FIG. 1 is an automobile 101. The vehicle 100 is shown with three exemplary cameras 150a, 150b, 150c (generally referred to as 150) and a radar system 130, which is a USRR system 135 in the exemplary embodiment. The fusion according to one or more embodiments is performed by a controller 110.

The controller 110 includes processing circuitry to implement a deep learning convolutional neural network (CNN). The processing circuitry may include an application specific integrated circuit (ASIC), an electronic circuit, a processor 115 (shared, dedicated, or group) and memory 120 that executes one or more software or firmware programs, as shown in FIG. 1, a combinational logic circuit, and/or other suitable components that provide the described functionality. The controller 110 may provide information or a control signal to one or more vehicle systems 140 based on the fusion of data from the radar system 130 and cameras 150. The vehicle systems 140 may include a collision avoidance system, adaptive cruise control system, or fully autonomous driving system, for example.

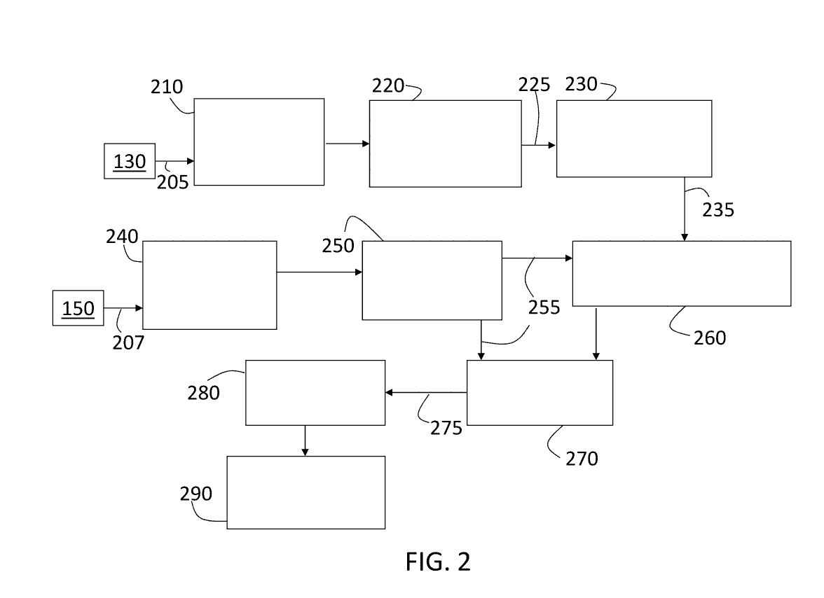

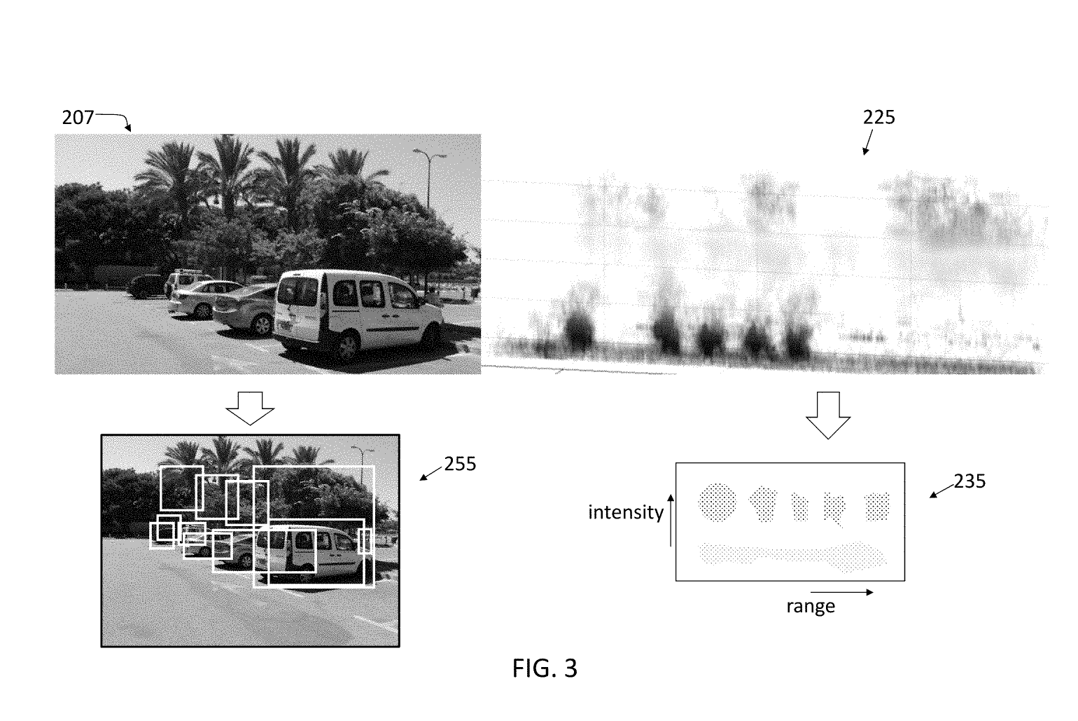

FIG. 2 is a process flow of a method of performing fusion of radar and vision sensor systems according to one or more embodiments. Some or all of the processes may be performed by the controller 110. Some or all of the functionality of the controller 110 may be included in the radar system 130 according to alternate embodiments. At block 210, obtaining radar reflections 205 includes obtaining data from the radar system 130, which is the USRR system 135 according to the explanatory embodiment. In alternate embodiments, the radar reflections 205 may be obtained from multiple radar systems 130. For example, two or more USRR systems 135 may have fields of view that overlap with the field of view of a camera 150. Performing pre-processing, at block 220, includes performing known processing functions such as performing a fast Fourier transform (FFT) on the received radar reflections, considering the FFT values that exceed a predefined threshold value, and grouping those values into three-dimensional clusters 225, as shown in FIG. 3. Projecting to an image plane, at block 230, includes creating a two-dimensional range map 235 from the three-dimensional clusters 225 identified at block 220. The range map 235 indicates the range of each of the received reflections that exceeds the threshold along one axis and the respective intensity along a perpendicular axis. An exemplary range map 235 is shown in FIG. 3.

At block 240, obtaining image frames 207 includes obtaining images from each of the cameras 150. An image frame 207 that corresponds with the exemplary three-dimensional clusters 225 is also shown in FIG. 3. Processing the image frames 207, at block 250, results in a visual feature map 255. The processing of the image frames 207 includes a known series of convolutional processes in which the matrix of pixels of the image frames 207 and, subsequently, the result of the previous convolutional process undergo a convolution with a kernel matrix. The initial kernel values may be random or determined via experimentation and are refined during a training process. The visual feature map 255 indicates features (e.g., trees, vehicles, pedestrians) in the processed image frames 207.

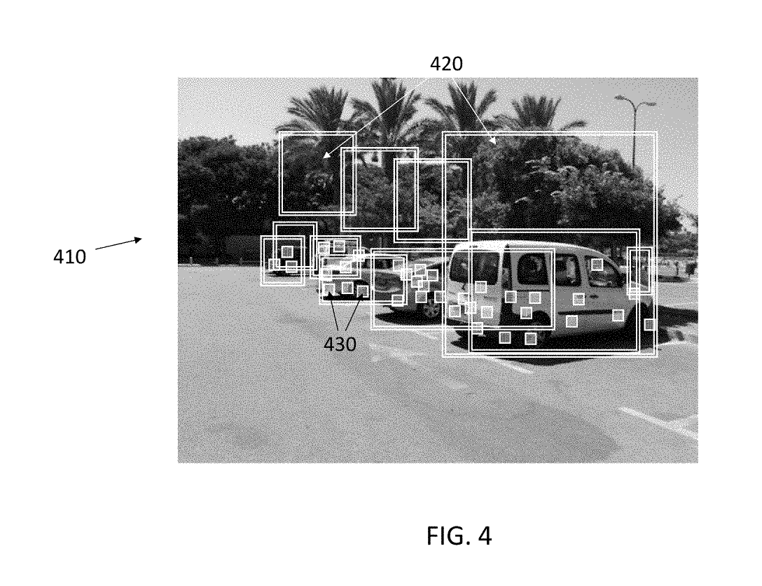

At block 260, generating one or more region of interest (ROI) proposals includes using the range map 235 resulting from the radar reflections 205 and the visual feature map 255 resulting from the image frames 207 as inputs. Specifically, objects that are indicated in the radar map 235 and visual features that are identified in the visual feature map 255 are compared to determine an overlap as the ROI. The visual feature map 255 and ROI proposals (generated at block 260) are used for region proposal (RP) pooling, at block 270. RP pooling, at block 270, refers to normalizing the ROI proposals (generated at block 260) to the same size. That is, each ROI proposal may be a different size (e.g., 32-by-32 pixels, 256-by-256 pixels) and may be normalized to the same size (e.g., 7-by-7 pixels) at block 270. The pixels in the visual feature map 255 that correspond with ROI proposals are extracted and normalized to generate a normalized feature map 275. This process is further discussed with reference to FIG. 4. Classifying and localizing the normalized feature map 275, at block 280, involves another neural network process. Essentially, the proposals in the normalized feature map 275 are analyzed based on known object identification processing to determine if they include an object. If so, the object is classified (e.g., pedestrian, vehicle).

Providing output, at block 290, can include multiple embodiments. According to an embodiment, the output may be a display 410 to the driver overlaying an indication of the classified objects in a camera display. The display may include an image with boxes indicating the outline of classified objects. Color or other coding may indicate the classification. The boxes are placed with a center location u, v in pixel coordinates and a size (width W and height H) in pixel units. Alternately or additionally, the output includes information that may be provided to one or more vehicle systems 140. The information may include the location and classification of each classified object in three-dimensional space from the vehicle perspective. The information may include the detection probability, object geometry, velocity (i.e., heading angle, velocity), which is determined based on Doppler information obtained by the radar system 130 or frame-by-frame movement determined based on the cameras 150, and position (e.g., in the x, y coordinate system) for each object.

FIG. 3 shows exemplary results obtained in the process flow of a method of performing fusion of radar and vision sensor systems according to one or more embodiments. An exemplary image frame 207 is shown. The exemplary image frame 207 displays objects (e.g., parked cars) that reflect radio frequency (RF) transmissions from the radar system 130 as well as less reflective objects (e.g., trees). Exemplary three-dimensional clusters 225 obtained at block 220 are also shown in FIG. 3 for the same scenario shown in the exemplary image frame 207. As the shading of the three-dimensional clusters 225 indicates, the parked cars reflect more energy than other objects in the scene. An exemplary range map 235 is also shown in FIG. 3. The range map 235 is a two-dimensional projection of three-dimensional clusters 225. Based on processing of the exemplary image frame 207, a resulting exemplary visual feature map 255 is shown in FIG. 3, as well. The features identified in the visual feature map 255 are bounded by rectangles, as shown. As FIG. 3 indicates, the rectangles that bound the different features are of different sizes (i.e., include a different number of pixels). This leads to the need for the pooling at block 270.

FIG. 4 shows an exemplary image 410 with features 420 from a visual feature map 255 and points 430 from a range map 235 used to generate ROI proposals according to one or more embodiments. The features 420 from the feature map 255 are indicated within double-line rectangles, and range map 235 points 430 are indicated by the single-line rectangles. As FIG. 4 indicates, the trees are indicated as features 420 but are not points 430 from the range map 235. Thus, because the trees do not represent an area of overlap between the features 420 and points 430, the trees would not be indicated within any ROI at block 260. Even if ROIs generated at block 260 include trees, bushes, and the like, the classification, at block 280, would eliminate these objects from the output at block 290.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of fusing a radar system and a vision sensor system, the method comprising:
obtaining radar reflections resulting from transmissions of radio frequency (RF) energy;
obtaining image frames from one or more vision sensor systems;
generating region of interest (ROI) proposals based on the radar reflections and the image frames; and
providing information about objects detected based on the ROI proposals.

2. The method according to claim 1, further comprising obtaining a radar map from the radar reflections, wherein the radar map indicates an intensity of processed reflections at respective range values.

3. The method according to claim 2, further comprising obtaining a visual feature map from the image frames, wherein the obtaining the visual feature map includes processing the image frames using a neural network.

4. The method according to claim 3, wherein the generating the ROI proposals includes finding an overlap among features of the visual feature map and points in the radar map.

5. The method according to claim 2, wherein the obtaining the radar map includes projecting three-dimensional clusters onto an image plane.

6. The method according to claim 5, further comprising obtaining the three-dimensional clusters based on performing a fast Fourier transform of the radar reflections.

7. The method according to claim 3, wherein the obtaining the visual feature map includes performing a convolutional process.

8. The method according to claim 7, wherein the performing the convolutional process includes performing a series of convolutions of the image frames with a kernel matrix.

9. The method according to claim 1, wherein the providing the information includes providing a display to a driver of a vehicle that includes the radar system and the vision sensor system.

10. The method according to claim 1, wherein the providing the information is to a vehicle system of a vehicle that includes the radar system and the vision sensor system, the vehicle system including a collision avoidance system, an adaptive cruise control system, or an autonomous driving system.

11. A fusion system, comprising:
a radar system configured to obtain radar reflections resulting from transmissions of radio frequency (RF) energy;
a vision sensor system configured to obtain image frames from one or more vision sensor systems; and
a controller configured to generate region of interest (ROI) proposals based on the radar reflections and the image frames, and provide information about objects detected based on the ROI proposals.

12. The system according to claim 11, wherein the controller is further configured to obtain a radar map from the radar reflections, the radar map indicating an intensity of processed reflections at respective range values.

13. The system according to claim 12, wherein the controller is further configured to obtain a visual feature map based on processing the image frames using a neural network.

14. The system according to claim 13, wherein the controller is further configured to generate the ROI proposals based on finding an overlap among features of the visual feature map and points in the radar map.

15. The system according to claim 12, wherein the controller is further configured to obtain the radar map based on projecting three-dimensional clusters onto an image plane.

16. The system according to claim 15, wherein the controller is further configured to obtain the three-dimensional clusters based on performing a fast Fourier transform of the radar reflections.

17. The system according to claim 13, wherein the controller is further configured to obtain the visual feature map based on performing a convolutional process.

18. The system according to claim 17, wherein the controller is further configured to perform the convolutional process based on performing a series of convolutions of the image frames with a kernel matrix.

19. The system according to claim 11, wherein the controller is further configured to provide the information as a display to a driver of a vehicle that includes the radar system and the vision sensor system.

20. The system according to claim 11, wherein the controller is further configured to provide the information to a vehicle system of a vehicle that includes the radar system and the vision sensor system, the vehicle system including a collision avoidance system, an adaptive cruise control system, or an autonomous driving system.
